(19) United States
(12) Patent Application Publication
(10) Pub. No.: US 2022/0057150 A1
(43) Pub. Date: Feb. 24, 2022

(54) Portable Cooling Assembly

(71) Applicant: James Wiggins, Atlanta, GA (US)

(72) Inventor: James Wiggins, Atlanta, GA (US)

(21) Appl. No.: 16/996,497

(22) Filed: Aug. 18, 2020

(51) Int. Cl. F28F 9/013; F04D 25/06; F04D 29/52

(52) U.S. Cl. CPC F28F 9/013; F04D 29/522; F04D 25/06

(57) ABSTRACT

A portable cooling assembly for enhancing the cooling ability of an electric fan includes a tube that is coiled into a spiral and the tube contains a refrigerant. A pair of arms is each coupled to and extends away from the tube. Each of the arms is concavely arcuate to engage opposite sides of the fan for retaining the tube on the fan. In this way the refrigerant in the tube can cool air being blown thereacross by the fan for enhancing comfort for a user in a hot environment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooling devices and more particularly pertains to a new cooling device for enhancing the cooling ability of an electric fan.

### (2) Description of Related Art Including Information Disclosed Under 37 CFR 1.97 and 1.98

The prior art relates to cooling devices. The prior art discloses an immersible heat exchanger comprised of a coil that has cool water therein for exchanging heat with a heated material. The prior art also discloses a portable air cooler that relies on tap water ran through a coil for exchanging heat with ambient air. The prior art discloses a heat exchanger for heating an enclosure or a body of water that includes a coil filled with a heated fluid. The prior art also discloses a heat exchanger that is positionable in front of a fan, and that is fluidly coupled to a faucet for having water pushed through the heat exchanger. In no instance does the prior art disclose a closed circuit heat exchanger that is filled with a refrigerant and that can be removably attached to a portable fan.

### BRIEF SUMMARY OF THE INVENTION

An embodiment of the disclosure meets the needs presented above by generally comprising a tube that is coiled into a spiral and the tube contains a refrigerant. A pair of arms is each coupled to and extends away from the tube. Each of the arms is concavely arcuate to engage opposite sides of the fan for retaining the tube on the fan. In this way the refrigerant in the tube can cool air being blown thereacross by the fan for enhancing comfort for a user in a hot environment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a portable cooling assembly according to an embodiment of the disclosure.

FIG. 2 is a back perspective view of an embodiment of the disclosure.

FIG. 3 is a cross sectional view taken along line 3-3 of FIG. 1 of an embodiment of the disclosure.

FIG. 4 is a cross section view taken along line 3-3 of FIG. 1 of an alternative embodiment of the disclosure.

FIG. 5 is a perspective in-use view of an embodiment of the disclosure.

FIG. 6 is a left side in-use view of an embodiment of the disclosure.

FIG. 7 is a front in-use view of an embodiment of the disclosure.

### DETAILED DESCRIPTION OF THE INVENTION

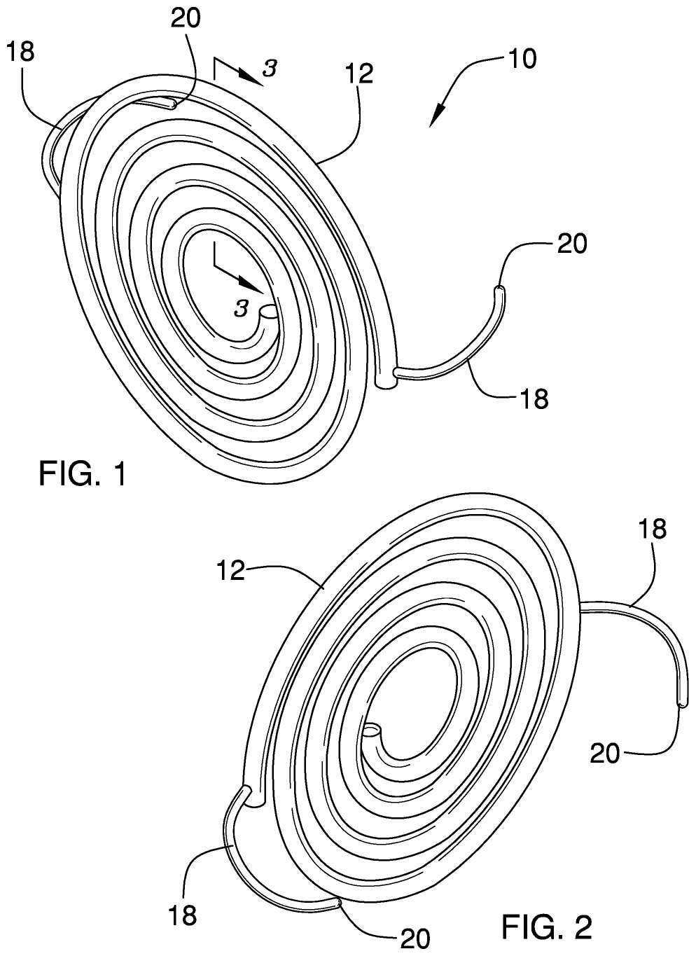

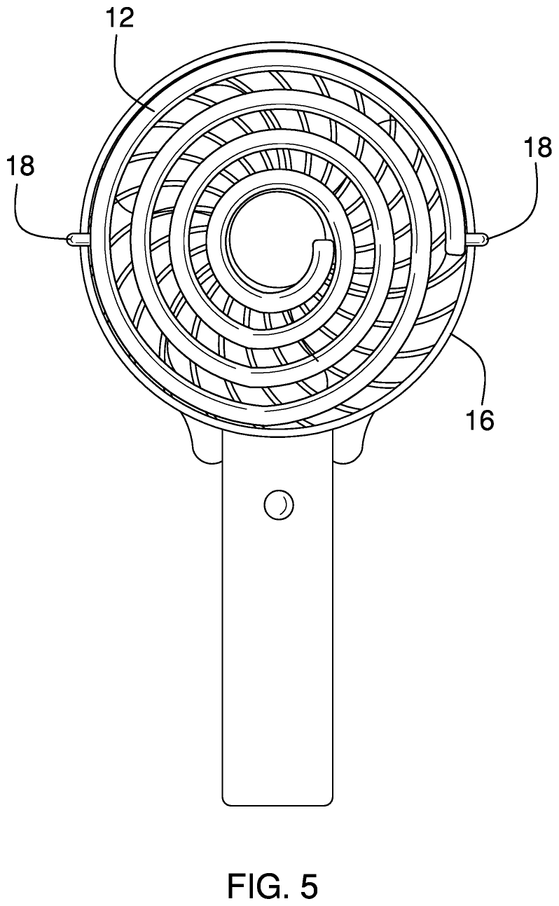

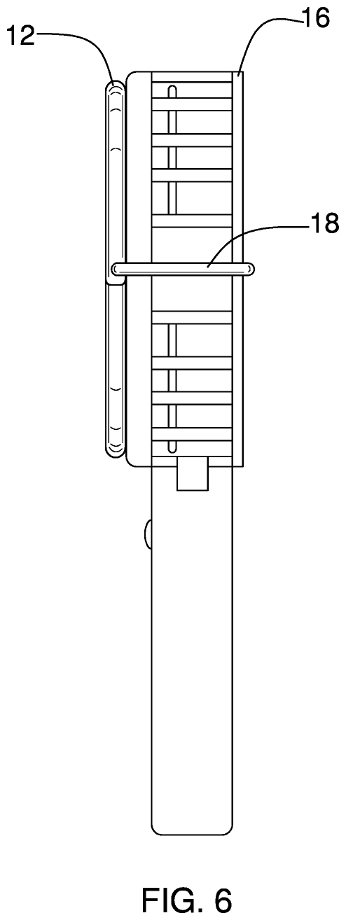

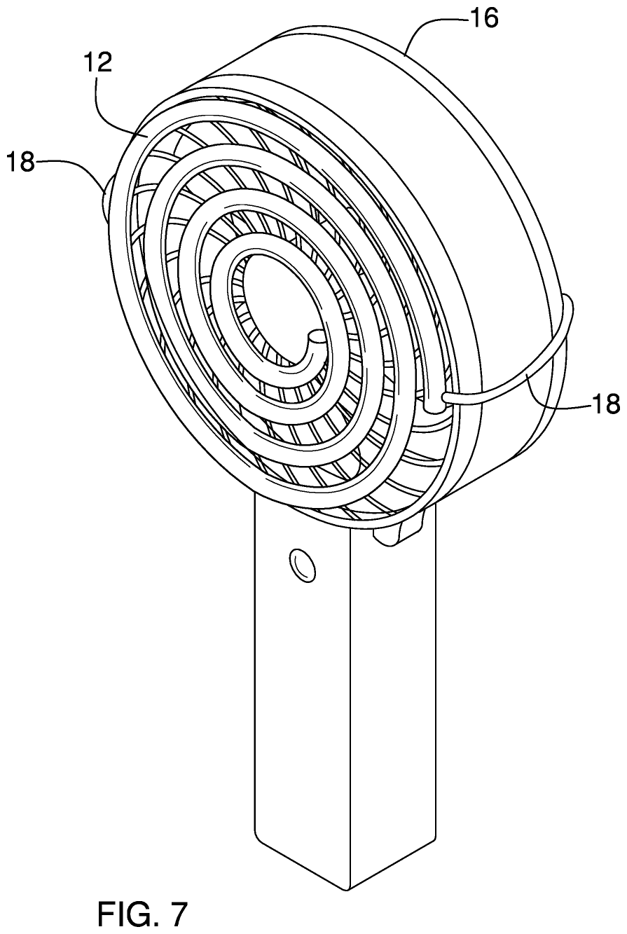

With reference now to the drawings, and in particular to FIGS. 1 through 7 thereof, a new cooling device embodying the principles and concepts of an embodiment of the disclosure and generally designated by the reference numeral 10 will be described.

As best illustrated in FIGS. 1 through 7, the portable cooling assembly 10 generally comprises a tube 12 that is coiled into a spiral. The tube 12 contains a refrigerant 14 and the tube 12 is comprised of a thermally conductive material. In this way thermal communication is facilitated between the liquid refrigerant 14 and ambient air to cool the ambient air. The tube 12 forms a flattened spiral to facilitate the tube 12 to be positioned in front of a fan 16. The fan 16 may be a portable electric fan that a user might take to an outdoor sporting event or any other area where the user might need to be cooled.

A pair of arms 18 is provided and each of the arms 18 is coupled to and extends away from the tube 12. Each of the arms 18 is concavely arcuate to engage opposite sides of the fan 16 for retaining the tube 12 on the fan 16. In this way the refrigerant 14 in the tube 12 can cool air being blown thereacross by the fan 16 for enhancing comfort for a user in a hot environment. Each of the arms 18 has a distal end 20 with respect to the tube 12 and each of the arms 18 is positioned on opposite sides of the flattened spiral defined by the tube 12. Each of the arms 18 is comprised of a resiliently bendable material thereby facilitating the arms 18 to be positioned around the fan 16.

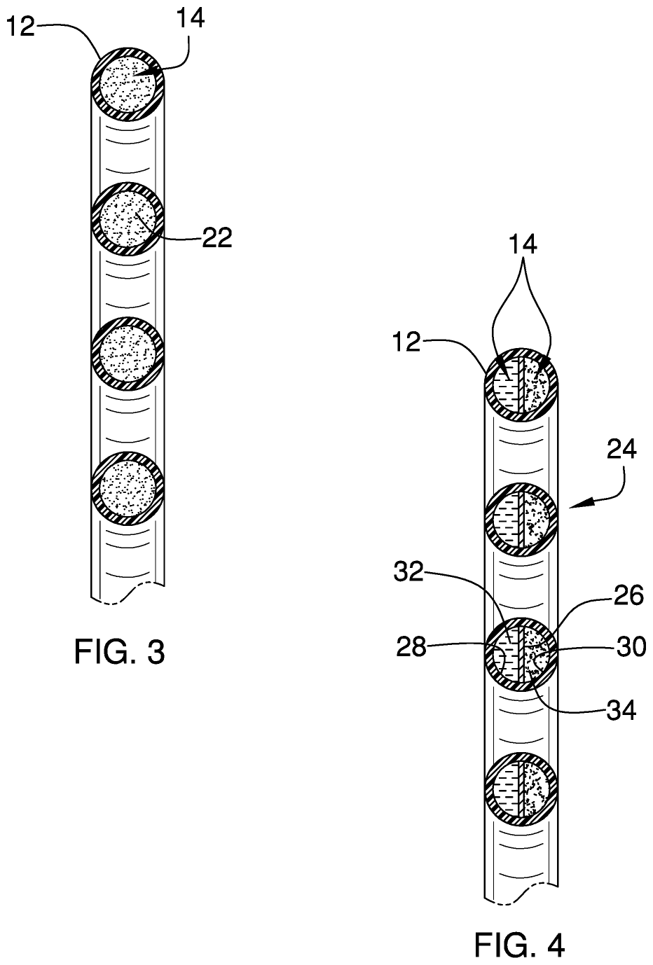

As is most clearly shown in FIG. 3, the refrigerant 14 may comprise a freezable gel 22 that can be frozen. The tube 12 can be placed in a freezer to freeze the freezable gel 22 prior to placing the tube 12 on the fan 16. In this way the freezable gel 22 can cool the air that is blown across the tube 12 by the fan 16 for enhancing cooling the user. Moreover, the freezable gel 22 can be continuously refrozen for repeated use.

In an alternative embodiment 24 as is most clearly shown in FIG. 4, a membrane 26 is positioned within the tube 12 to define a first chamber 28 and a second chamber 30 within the tube 12. Moreover, the membrane 26 may be a fluid permeable membrane such as cellulose or the like. The refrigerant 14 may comprise water 32 contained in the first chamber 28 and ammonium nitrate 34 contained in the second chamber 30. The water 32 and the ammonium nitrate 34 pass through the membrane 26 to produce an endothermic reaction. In this way the tube 12 cools the air that is blown across the tube 12 and the tube 12 is discarded once the refrigerant 14 becomes depleted.

In use, the tube 12 is positioned against the front of fan 16 and each of the arms 18 is urged away from each other to extend around opposite sides of a housing of the fan 16. Each of the arms 18 is subsequently released to engage the housing of the fan 16 thereby retaining the tube 12 on the fan 16. The fan 16 is turned on to blow air across the tube 12 and the refrigerant 14 in the tube 12 cools the air. In this way the user can cool themselves when the user is in a hot environment. The tube 12 can be placed in the freezer to refreeze the freezable gel 22 for subsequent use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable cooling assembly for mounting a cooling coil onto an electric fan for cooling a user, said assembly comprising:
a tube being coiled into a spiral, said tube containing a refrigerant; and
a pair of arms, each of said arms being coupled to and extending away from said tube, each of said arms being concavely arcuate wherein each of said arms is configured to engage opposite sides of the fan for retaining said tube on the fan wherein said refrigerant in said tube is configured to cool air being blown thereacross by the fan for enhancing comfort for a user in a hot environment.

2. The assembly according to claim 1, wherein said tube is comprised of a thermally conductive material thereby facilitating thermal communication between said liquid refrigerant and ambient air wherein said tube is configured to cool the ambient air.

3. The assembly according to claim 1, wherein said tube forms a flattened spiral wherein said tube is configured to be positioned in front of a fan.

4. The assembly according to claim 3, wherein each of said arms has a distal end with respect to said tube, each of said arms being positioned on opposite sides of said flattened spiral defined by said tube.

5. The assembly according to claim 1, wherein each of said arms is comprised of a resiliently bendable material thereby facilitating said arms to be positioned around the fan.

6. A portable cooling assembly for mounting a cooling coil onto an electric fan for cooling a user, said assembly comprising:
a tube being coiled into a spiral, said tube containing a refrigerant, said tube being comprised of a thermally conductive material thereby facilitating thermal communication between said liquid refrigerant and ambient air wherein said tube is configured to cool the ambient air, said tube forming a flattened spiral wherein said tube is configured to be positioned in front of a fan; and
a pair of arms, each of said arms being coupled to and extending away from said tube, each of said arms being concavely arcuate wherein each of said arms is configured to engage opposite sides of the fan for retaining said tube on the fan wherein said refrigerant in said tube is configured to cool air being blown thereacross by the fan for enhancing comfort for a user in a hot environment, each of said arms having a distal end with respect to said tube, each of said arms being positioned on opposite sides of said flattened spiral defined by said tube, each of said arms being comprised of a resiliently bendable material thereby facilitating said arms to be positioned around the fan.

7. The assembly according to claim 6, wherein said refrigerant comprises a freezable gel, said tube being positionable in a freezer wherein said freezable gel is configured to be frozen.

8. The assembly according to claim 6, further comprising said tube includes a membrane being positioned within said tube to define a first chamber and a second chamber in said tube, said membrane extending along a full length of said tube, said membrane being comprised of a fluid permeable material such that said first chamber is in fluid communication with said second chamber.

9. The assembly according to claim 8, wherein said refrigerant comprises water being positioned within said first chamber.

10. The assembly according to claim 9, wherein said refrigerant comprises ammonium nitrate being positioned within said second chamber thereby facilitating the water to mix with said ammonium nitrate thereby producing an endothermic reaction wherein said refrigerant is configured to cool the air being blown across said tube.

11. A portable cooling system for mounting a cooling coil onto an electric fan for cooling a user, said assembly comprising:
a fan having a housing, said housing having a front side and an outer wall;
a tube being coiled into a spiral, said tube containing a refrigerant, said tube being comprised of a thermally conductive material thereby facilitating thermal communication between said liquid refrigerant and ambient air wherein said tube is configured to cool the ambient air, said tube forming a flattened spiral thereby facilitating said tube to be positioned on said front side of said fan; and
a pair of arms, each of said arms being coupled to and extending away from said tube, each of said arms being concavely arcuate thereby facilitating each of said arms to engage opposite sides of said fan for retaining said tube on the fan wherein said refrigerant in said tube is configured to cool air being blown thereacross by the fan for enhancing comfort for a user in a hot environment, each of said arms having a distal end with respect to said tube, each of said arms being positioned on opposite sides of said flattened spiral defined by said tube, each of said arms being comprised of a resiliently bendable material thereby facilitating said arms to be positioned around said outer wall of said fan.
